(19) United States
(12) Patent Application Publication
(10) Pub. No.: US 2002/0135841 A1
(43) Pub. Date: Sep. 26, 2002

(54) Transceiver device for cooperation with an optical fiber

(76) Inventor: Marcus Egbert Kole, Eindhoven (NL)

Correspondence Address: U.S. Philips Corporation, 580 White Plains Road, Tarrytown, NY, 10591, US

(21) Appl. No.: 10/103,236

(22) Filed: Mar. 21, 2002

(30) Foreign Application Priority Data
Mar. 26, 2001 (EP) 01201114.4

(51) Int. Cl. H04B 10/00; H04B 10/12

(52) U.S. Cl. 359/152; 359/173

(57) ABSTRACT

A transceiver device (30) for cooperation with an optical fiber (1) comprises a beam generator (32), a semi-transparent element (35) and a sensor (31). The sensor (31) is two-dimensional and position sensitive. Part (44) of the beam (33) generated by the beam generator (32) is sent to the sensor (31). A comparison is made of the position of the beam (44) generated by the beam generator (32) and detected by the sensor (31) with the position of a beam (44) exiting the optical fiber. Means (38) are present for controlling a controllable beam displacing element (39) provided between the beam generator (32) and the semi-transparent element (35), such that the beam (44) generated by the beam generator (32) hits the sensor (31) at the same position as the beam (2) exiting the optical fiber (1).

The invention relates to a transceiver device according to the preambule of claim 1.

Such a device is known from a Japanese patent application JP-A-11/023916 laid open to public inspection. In this known device, the optical fiber must be aligned both with the beam generator and with the sensor by precise and consequently costly mechanical means.

It is an object of the invention to provide a transceiver device in which the alignment is realized in a simple and preferably automatic manner. According to the invention, this object is realized in a transceiver device being characterized in that:

the sensor is two-dimensional and position sensitive,

a controllable beam-shifting element is provided between the beam generator and the semi-transparent element,

a first control means are coupled to the sensor and to the controllable beam-shifting element for generating a control signal for the controllable beam-shifting element, said control signal in response to a position signal received from the sensor,

a second control means for sending a second portion of the beam to the sensor.

As a result, the position of the beam generated by the beam generator on an entry surface of the optical fiber has been coupled back by means of the sensor, via the first control means and a controllable beam-shifting element, by detecting at least a portion of that beam in a particular position on the sensor. This renders it possible to shift the position of the beam generated by the beam generator on the sensor in such a manner that said position is the same as a position where a beam outputted by the fiber hits the sensor. As a result, the entering beam reaches the optical fiber in the same position where the exiting beam exits the fiber.

In an embodiment of a transceiver according to the invention the controllable beam-shifting element is electrically controllable.

In another embodiment of the transceiver according to the invention the second control means comprise a mirroring element, the semi-transparent element comprises a beam-splitting prism, and the mirroring element comprises a reflectorized side of the beam-splitting prism.

As a result, a relatively compact device is obtained.

In an embodiment of the transceiver according to the invention the reflectorized side and/or an entry side onto which the beam generated by the beam generator is incident is curved.

As a result, the beam generated by the beam generator is focused both on an entry surface of the optical fiber and on the sensor by the curved surfaces of the beam-splitting prism by means of a relatively compact device, with no additional optical elements or using relatively simple optical elements for focusing.

In another embodiment of the transceiver device according to the invention the transceiver device the position sensitive sensor comprises a plurality of separate sensor elements, each of the separate sensor element delivering an output signal whose magnitude depends on an intensity of the beam incident to the respective sensor element, a largest dimension of any sensor element is at most equal to half the diameter of a diffraction-limited spot of the beam outputted by the optical fiber at the location of the sensor elements, a diametrical dimension of the portion of the sensor provided with sensor elements is larger than a diameter of the beam outputted by the optical fiber, the position sensitive sensor further comprising means for determining the magnitude of the output signal from each sensor element.

This renders it possible to determine the position of the beam on the sensor by means of sensor elements having extremely small dimensions and thus a very small capacitance.

The invention will now be explained in more detail with reference to the appended drawings, in which:

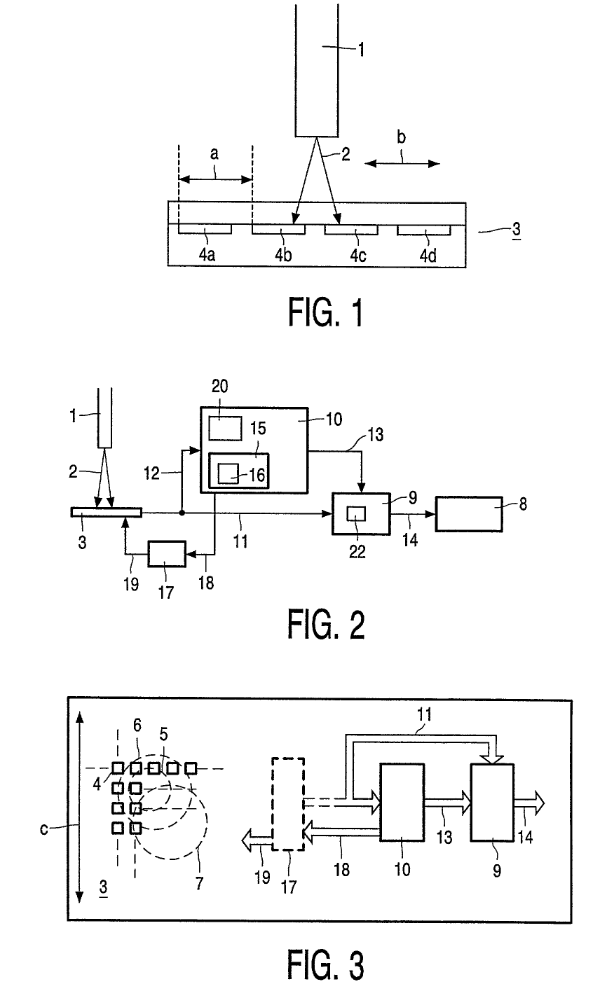

FIG. 1 diagrammatically shows an optical fiber and a sensor; according to the invention,

FIG. 2 diagrammatically shows a circuit for supplying signals from a sensor to a processing circuit; according to the invention,

FIG. 3 diagrammatically shows an integrated circuit according to FIG. 2;

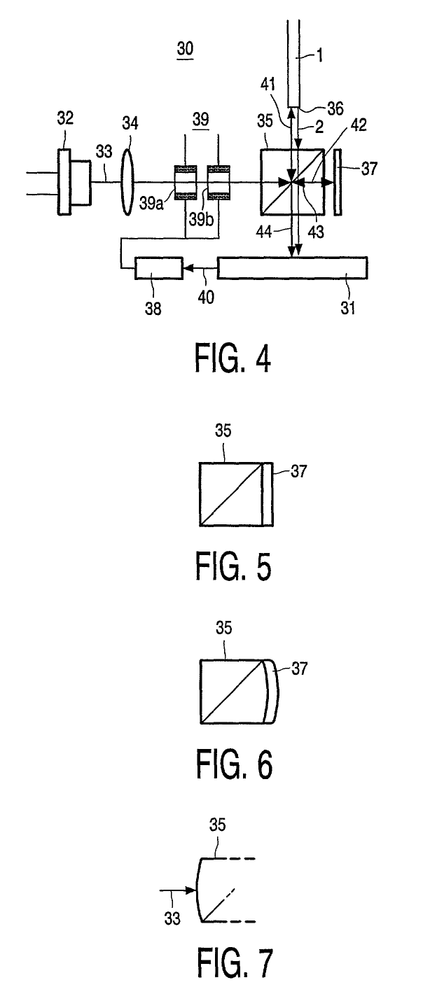

FIG. 4 diagrammatically shows a transceiver device for cooperation with an optical fiber; and

FIGS. 5, 6 and 7 show various embodiments of a beam-splitting prism.

In FIG. 1, reference numeral 1 indicates an optical fiber, outputting a beam 2. The outputted beam 2 hits a sensor 3. The sensor 3 comprises sensor elements 4a, 4b, 4c and 4d, which are sensitive to an inversion of the beam 2. In many cases, each of the sensor elements 4a . . . 4d is a photodiode, which deliveres a voltage a potential difference across a capacitor element in response to an incident radiation. The larger a surface area of the sensor element, the bigger the associated capacitance. It is desirable to keep the associated capacitance as small as possible so as to be able to process signals in the shape of modulated beams 2 at a maximum modulation frequency. Prior art sensors try to find a compromise between maintaining minimum dimensions for the sensors 4a, . . . , 4d, hereinafter also referred to as sensors 4, versus the capacitance associated therewith and on the other hand the necessity for having relatively large physical dimensions for enabling an easy mechanical positioning of one end of the optical fiber 1 with respect to the sensor 3. The larger the sensor 3, the less stringent the requirements imposed on the mechanical precision with which the end of the optical fiber 1 is to be positioned with respect to the sensor 3.

The sensor 3 comprises a big number of sensitive sensor elements 4 (cf. FIG. 3). A diametrical dimension a of a pixel of a sensor element 4a is indicated by arrow a. A beam 2 from an optical fiber 1 preferably has a diameter which is as small as the diametrical dimension a. Nevertheless, it is not possible to have a spot with a diameter smaller than that determined by the numeric aperture of the optical fiber 1. According to the wave character of the beam which is transported through the optical fiber 1 and which exits said optical fiber 1 as the beam 2. the minimum spot size that can be achieved is the diffraction-limited spot size.

The diametrical dimension a of a sensor element is less than half the diameter of a diffraction-limited spot of the beam 2 on the sensor 3. In this way, a number of sensor elements 4 are hit by the beam 2. A spot having a diffraction-limited diameter is diagrammatically indicated by reference numeral 5 in FIG. 3.

A major problem regarding the precise alignment of an optical fiber 1 with respect to the sensor 3., the sensor 3 converting an optical signal present in the beam 2 into another type of signal, such as an electrical signal or a magnetic signal or a temperature signal or the like, is the necessity of a permanently precise alignment of the end of the optical fiber 1 with respect to the sensor 3. Said alignment is subject to mechanical jolts and vibrations. Such jolts and vibrations cause the beam 2 and the sensor 3 to move with respect to each other, as is diagrammatically indicated by the double arrow b. It has not been attempted within the framework of the present invention to prevent the occurrence of vibrations and jolts as much as possible, as in the prior art, but instead to design the sensor 3 such that movements of the beam 2 with respect to the sensor 3 do not have an adverse effect on the signals delivered by the sensor 3.

In FIG. 3, reference numerals 6 and 7 show in two positions the dimension of the beam 2 at the location of the sensor 3 by way of example. It stands to reason that a diametrical dimension of the beams 6 and 7 is at least as large as a corresponding diametrical dimension of the diffraction-limited spot 5.

FIG. 2 shows the manner in which output signals from the various sensor elements 4a . . . 4d are supplied to a processing device 8, via a supplying means 9. Said supplying means 9 do not supply each and every output signal from each sensor element 4 of the sensor 3 to the processing device 8. In order to enable this, the supplying means 9 are adjustable. Furthermore, adjustment means 10 for controlling the adjustment of the supplying means 9 in dependence on the output signals from the sensor elements 4 of the sensor 3, are presented. Output signals from the sensor elements 4 of the sensor 3 are supplied to an input of the supplying means 9 via a line 11. The same output signals are supplied to an input of the adjustment means 10 via a line 12. The adjustment means 10 are arranged for delivering, via a line 13 in a manner yet to be described, a signal which determines for each sensor element 4 whether the output signal from the sensor element in question that is present on the line 11 at that moment is or it is not be supplied to the processing device 8 via the line 11 by the supplying means 9.

The adjustment means 10 comprise means 15 for determining the magnitude of a signal which enters the adjustment means 10 via the line 12. To that end, said means 15 comprise, a threshold circuit 16. Depending on the magnitude of the output signal on the line 12, an output signal from the adjustment means 10 is present on the line 13, which adjustment means 10 adjust the supplying means 8 so as to relay that same output signal, which is present on the line 11 at an input of the supplying means 9, to the processing device 8 via a line 14.

A control device 17 which is known per se, see FIG. 3, arranges for the sensor elements 4 to be read. The speed at which said reading takes place is sufficiently high to enable precise following of the modulation in the beam 2.

Since the area covered with sensor elements 4 is larger than the diameter of the beam 2 as indicated by reference numerals 6 and 7 (see the diametrical dimension c), only those sensor elements 4 that are present within the areas encompassed by circles 6 and 7 induce an output signal different from zero on the lines 11 and 12, respectively. All other sensor elements 4 induce a zero signal and do not contribute to the signal on the line 14. It is not much use, therefore, to read the sensor elements 4 that are not hit by the beam 2 anew each time. The adjustment means 10 are coupled to the control device 17 via a line 18. Via said line 18, the adjustment means 10 inform the control device 17 which sensor elements 4 induce a zero signal and consequently need not be included in the regular readout of the sensor elements 4. Only the sensor elements 4 that are hit by a beam 2 need to be read anew each time, and preferably also a circle of sensor elements surrounding said elements, so as to be able to follow the aforesaid shifts of the beam 2 with respect to the sensor 3.

The adjustment of the control device 17 as described above for reading only a limited number of the sensor elements 4 on the sensor 3 may take place every time the sensor elements 4 are read, but it may alternatively be done once from time to time, after which the adjustment of the control device 17 is not changed for a number of readouts. The readjustment of the control device 17 via the line 18 only needs to take place at such a renewal frequency that the control device is able to follow the frequency of the shifts of the beam 2 with respect to the sensor 3 in accordance with the Nyquist criterion, i.e. the period between predetermined points in time at which the control device 17 is reset by the adjustment means is smaller than half the period of the highest frequency of a shift of the beam 2 with respect to the sensor 3. The adjustment means 10 may be provided with timer means 20 for that purpose.

FIG. 3 diagrammatically shows an integrated circuit 21 comprising the sensor 3 as well as the control device 17, the adjustment means 10, and the supplying means 9. The control device 17 and/or the adjustment means 10 and/or the supplying means 9 need not necessarily be arranged on the same integrated circuit as the sensor 3.

In the foregoing, the adjustment means 10 were described as being arranged such that some output signals from the sensor elements 4 of the sensor 3 are and other signals are not converted into a signal on the line 13, as a result of which the supplying means 9 relay the output signal in question from the line 11 to the line 14. Alternatively, it is possible to supply only those output signals that are strongest from the line 11 to the line 14, in the case of electrical signals, for example, those signals that have the biggest amplitude in current or in voltage or otherwise.

In the manner described above, the signal which is eventually put on the line 14 and which represents the modulated signal from the beam 2 at some point in time will be present independently of any movement of beam 2 with respect to the sensor 3. Furthermore, it can be arranged via the adjustment means 10 that only those output signals that are strongest will be supplied to the line 14.

The effect achieved by supplying adjustment signals to the control device 17 via the line 18 in such a manner that a new adjustment is obtained before the mechanical movement of the beam 2 with respect to the sensor 3 leads to signal loss, is that a dynamic and continuous alignment of the beam 2 takes place with respect to the sensor elements 4 of the sensor 3 that are read out.

The supplying means 9 may include a majority decision device 22. In the case of output signals from more than one sensor element 4 being supplied to the line 14 with every readout of the sensor 3, it may be advantageous to relay a signal as indicated by the majority of the sensor elements 4 read. Possibly, a weighting of the various output signals may take place. To output signals from a sensor element 4 in a position near a center of a beam diameter 7 could be assigned a greater weight than to an output signal from a sensor element 4 arranged near the edge or just beyond the edge of the beam diameter 7.

The alignment of the beam 2 with respect to the sensor 3 may also take place from time to time through transmission of a predetermined signal via the optical fiber 1 at predetermined points in time and detecting which sensor elements 4 respond in what way to the beam 2 resulting therefrom.

FIG. 4 shows a transceiver device 30. In a receiving mode, a beam 2 is outputted by an optical fiber 1 and hits a sensor 31. In a transmission mode, a beam generator 32, which is known per se, generates a beam 33, which is focused onto an entry surface 36 of the optical fiber 1 via suitable focusing means and semi-transparent elements 35, which are known per se.

Whereas only the alignment of the beam 2 with the sensor 31 was described in the foregoing, the present case also concerns the alignment of the beam 33 with respect to the optical fiber 1. To that end, the device 30 comprises a semi-transparent element 35, a reflecting element 37, a two-dimensional, position-sensitive sensor 31, control means 38, and a beam-shifting element 39 for shifting the beam 33.

Initially, a beam 2 is directed at the sensor 31 from the optical fiber 1. This provides information as to the position of the sensor 31 at which the beam 2 hits the sensor 31, both in the plane of drawing and perpendicularly to the plane of drawing of FIG. 4. This information is available on, inter alia, a line 40 of the sensor 31 to control device 38. The control device 38 comprises a memory portion in which the information in question can be stored for further processing, as will be described in more detail further below. Subsequently, the beam generator 32 transmits a beam 33 via the focusing device 34 in the direction of the semi-transparent element 35. There the beam 33 is split up into a beam 41 in the direction of the optical fiber 1 and a beam 42 which moves straight on in the direction of a mirror 37. In this embodiment, the mirror 37 is a flat mirror which reflects the beam 42 in the direction from where it came, as is indicated by means of the arrow point 43. Part of the radiation reflected by the mirror 37 is then reflected as a beam 44 by the semi-transparent element 35 in the direction of the sensor 31. It is true also for the beam 44 that the coordinates of the position where the beam 44 hits the sensor are relayed to the control device 38 via the line 40. The control device 38 thus 'knows' both the position where the beam 2 hits the sensor 31 and the position where the beam 44 hits the sensor. From the differences in position between the beams 2 and 44 on the sensor 31 it can be simply calculated, by means of suitable software known to those skilled in the art, in what direction and to what extent the beam 33 is to be shifted by the beam-shifting element 39 in order to ensure that the beam 44 hits the sensor 31 in exactly a substancially same position as the beam 2. Owing to the fact that the beam 44 extends in the same direction as the beam 2, the beam 41 will also extend in the same direction as the beam 2. Consequently, the beam 41 hits the surface 36 of the optical fiber 1 in the very position where the beam 2 exits, ensuring that the beam 44 hits the sensor 31 in a substancially exactly same position as the beam 2. Thus an excellent alignment of the beam generator 32 with the optical fiber 1 is obtained in a simple, non-mechanical manner.

Preferably, the beam-shifting element 39 is composed of two beam-shifting elements 39a and 39b which can be electrically driven and which are capable of shifting the beam in two different directions, preferably extending perpendicularly to each other. Such devices are formed, for example, by anisotropic birefringent optical plates, which are known per se. Such optical plates shift an incident beam parallel to itself to an extent which depends on the value of an electric field being applied. Also driveable beam-shifting elements other than the aforementioned ones may be used within the framework of the present invention. The only condition is that the position and/or the direction of an exiting beam differs from the position or the direction of an incident beam in dependence on a signal to be supplied, which signal may be an electrical, mechanical, piezo-electric, thermal signal, or the like.

In order to enhance the mechanical precision of the device, a beam-splitting prism may be used as the semi-transparent element 35.

Furthermore, the reflecting element 37 may be disposed on a lateral surface of a beam-splitting prism 35 as indicated in FIG. 5 with a view to obtaining a greater precision.

In order to obtain a greater precision and to lower the optical requirements imposed on the focusing device 34, for example if the length of the beam 44 is different from the length of the beam 41, one surface of a beam-splitting prism 35 on which the reflecting element 37 is arranged may be curved. A concave reflecting element 37 is shown in FIG. 6 by way of example. Depending on the circumstances, it may also be desirable to provide a convex reflecting element 37.

In order to further enhance the precision and to lower the requirements imposed on the quality of the focusing device 34, one surface of a beam-splitting prism 35 on which the beam 33 is incident may be curved, all this as diagrammatically shown in FIG. 7.

In order to enhance the sturdiness of the device, the semi-transparent element 35, for example the beam-splitting prism 35, may be arranged on the sensor 3.

It is noted that the provision of a curvature in the reflecting element 37 and/or on the entry surface of the beam 33 on the semi-transparent device 35 can help preventing the formation of a parasitic resonance cavity for a wavelength which may be transmitted by the beam generator but which is undesirable.

Preferably, albeit not necessarily, the two-dimensional, position-sensitive sensor 31 is a sensor as described with reference to FIGS. 1 to 3.

Various embodiments and modifications will now spring to mind to a person skilled in the art who has perused the above. All such embodiments and modifications are considered to fall within the scope of the invention.

1. A transceiver device (30) for cooperation with an optical fiber (1), the transceiver (30) comprising a beam generator (32) for generating a first beam (33), a first portion of the first beam (41) being inputted to the fiber (1), said transceiver (30) further comprising a semitransparent element (35) coupled to a sensor (31), said sensor (31) detecting a second beam (2) exiting the fiber (1), the transceiver (30) being characterized in that
the sensor (31) is two-dimensional and position sensitive,
a controllable beam-shifting element (39) is provided between the beam generator (32) and the semi-transparent element (35),
a first control means (38) are coupled to the sensor (31) and to the controllable beam-shifting element (39) for generating a control signal for the controllable beam-shifting element (39), said control signal in response to a position signal (40) received from the sensor (31),
a second control means (37) for sending a second portion (44) of the beam (33) to the sensor (31).

2. A transceiver (30) as claimed in claim 1 wherein the controllable beam-shifting element (39) is conceived for deflecting the beam (33) in two different directions.

3. A transceiver (30) as claimed in claim 2 wherein the two directions are substantially perpendicularly to each other.

4. A transceiver (30) as claimed in any of the preceding claims wherein the control signal is an electrical control signal.

5. A transceiver (30) as claimed in claims 1 to 4 wherein the second control means (37) comprises a mirroring element.

6. A transceiver (30) as claims in any of the claims 1 to 5 wherein the semitransparent element (35) comprises a beam-splitting prism.

7. A transceiver (30) as claimed in claim 6 wherein the mirroring element is included in a reflecting side of the beam-splitting prism.

8. A transceiver (30) as claimed in claim 7 wherein the reflecting side is curved.

9. A transceiver (30) as claimed in any of the claims 6 to 8 wherein an entry side of the beam-splitting prism is curved, the first beam (33) being incident to that side.

10. A transceiver (30) as claimed in any of the preceding claims wherein the position sensitive sensor (3, 31) comprises a plurality of separate sensor elements (4a . . . , 4d), each of the separate sensor element (4a . . . , 4d) delivering an output signal whose magnitude depends on an intensity of the beam incident to the respective sensor element (4a, 4d), a largest dimension (a) of any sensor element (4a, . . . , 4d) is at most equal to half the diameter of a diffraction-limited spot (5) of the beam (2) outputted by the optical fiber (1) at the location of the sensor elements (4a, . . . , 4d), a diametrical dimension (c) of the portion of the sensor provided with sensor elements (4) is larger than a diameter (6, 7) of the beam (2) outputted by the optical fiber (1), the position sensitive sensor further comprising means (15) for determining the magnitude of the output signal from each sensor element (4a, . . . , 4d).

11. A transceiver (30) as claimed in claim 10 comprising adjustable means (9) for supplying output signals delivered by the sensor elements (4a, . . . , 4d) to the processing device (8) as well as adjustment means (10) for adjusting the supply means (9) for supplying output signals depending on the magnitude of the output signal from the sensor element (4a, . . . , 4d), said adjustment means (10) comprise the means (15) for determining the magnitude of the output signal from each sensor element.

12. A transceiver (30) as claimed in claim 11 wherein the adjustment means (10) comprise a threshold circuit.

13. A transceiver (30) as claimed in claims 11 or 12 wherein the adjustment means (10) comprise timer means (20) for adjusting the supply means (9) at predetermined points of time.

14. A transceiver (30) as claimed in claims 11-13 wherein the adjustment means (10) adjust the supply means (9) for delivering the output signal having a relative biggest magnitude.

15. A transceiver (30) as claimed in claim 13 wherein the period between said predetermined points of time is smaller than half of the period of the highest frequency of a movement of a beam (2, 44) across the sensor (3, 31).

16. A transceiver (30) as claimed in claim 11 or 12 wherein the supply means (9) can be adjusted for supplying output signals from more than one sensor element (4a . . . , 4d), and in that means (22) are present for determining the signal supplied to the processing means (8) on the basis of output signals that are present.

17. A transceiver (30) as claimed in any of the claims 11-14 wherein the sensor (3) and the adjustment means (10) form part of a single integrated circuit (21).

18. A transceiver (30) as claimed in 17 wherein the supply means (9) form part of said single integrated circuit.

19. A transceiver (30) as claimed in 16 and any of the claims 17 or 18 wherein said determining means (15) form part of said single integrated circuit.
